(19) United States
(12) Patent Application Publication
(10) Pub. No.: US 2013/0297329 A1
(43) Pub. Date: Nov. 7, 2013

(54) Method for Brokering Purchases of Procedural Services

(71) Applicants: Vikash Banthia, Del Mar, CA (US); Vishal Banthia, San Diego, CA (US)

(72) Inventors: Vikash Banthia, Del Mar, CA (US); Vishal Banthia, San Diego, CA (US)

(21) Appl. No.: 13/672,508

(22) Filed: Nov. 8, 2012

Related U.S. Application Data
(60) Provisional application No. 61/642,778, filed on May 4, 2012.

(51) Int. Cl. G06Q 50/22

(52) U.S. Cl. CPC G06Q 50/22
USPC 705/2

(57) ABSTRACT

A method for brokering purchases of procedural services between a buyer and at least one professional service provider is a software-based system that negotiates transactions between potential clients and professional service providers by receiving, verifying, and negotiating appointment availabilities and appointment offers while providing privacy to both parties until a transaction is conducted. The system comprises the steps of receiving and indexing appointment openings from providers, receiving and indexing appointment offers from buyers, matching appointment opening with appointment offers, anonymizing appointment offers, and negotiating the exchange of personal information between both parties when a transaction is conducted, as well as provide ancillary product suggestions. The system provides functionality to match a submitted appointment offer anonymously with at least one professional service provider. Additionally, the system provides automated features that improve matching of the appointment opening and the appointment offer by user submitted parameters of system derived value optimums.

The current application claims a priority to the U.S. Provisional Patent application Ser. No. 61/642,778 filed on May 4, 2012.

### FIELD OF THE INVENTION

The present invention relates generally to a method for brokering services, more specifically, to a method for brokering purchases of procedural services between a buyer and at least one professional service provider.

### BACKGROUND OF THE INVENTION

The profitability of a service based business is greatly dependent on its ability to maximize its capacity utilization. For a service based business, maximizing utilization entails having all appointment slots constantly booked. Although maximum utilization may be optimal, there are many situations where a service based business will have unfilled appointment slots. This situation results in machine, capital goods, or fixed assets not being used, as well as time during which paid workers are idle. During these instances the service based business is under capacity and functioning at a higher cost per hour of operation. Costs can be divided into fixed costs and variable costs. Fixed costs can be further broken into long-term fixed costs such as machine, capital, or building costs and short-term costs such as worker wages. The cost per operation hour or cost per provided service can be dramatically reduced by increasing fixed cost utilization by.

Several industries have been able to adopt software systems to address this capacity utilization problem. For example, in the travel industry, companies such as Travelocity and Priceline use proprietary software systems to match prospective buyers with prospective sellers. Prospective buyers are able to input parameters, including price information, destination information, and desired service levels, and the software finds prospective sellers that match these criteria. Companies such as Travelocity and Priceline negotiate with hotels, airlines, rental car companies, cruises, and other services that buyers typically need to use when travelling. In the year 2000, Priceline used a similar business model to sell goods, including groceries and gasoline, although this business practice was later discontinued. Typically, the prospective buyers are very price sensitive and are able to receive substantial discounts relative to prices listed by the hotels, airlines, rental car companies, etc. At the same time, the hotels, airlines, rental car companies, etc., are able to utilize capacity that would have otherwise gone unused. A key feature of these systems is that bids from potential buyers are time sensitive, so that both potential buyers and potential sellers must agree to proceed with a transaction within a limited time window. U.S. Pat. No. 5,794,207 discloses such a system specifically designed for the travel industry.

One industry that experiences the capacity utilization problem is the medical profession, and in particular providers of surgical and nonsurgical cosmetic and therapeutic procedures. These providers frequently have large blocks of time during the middle of the day in which few buyers set up appointments. Unlike in situations that require intensive patient-provider interaction and invasive procedures, many cosmetic and therapeutic procedures can be done in a relatively short time window and without having extensive familiarity with a patient. Buyers for these procedures tend to be more price sensitive and place less value on a personal relationship with the provider. There is therefore a great opportunity for these providers to offer these services at a discounted price during hours when the providers are not fully utilizing their capacity. Currently, no software system specifically addresses the needs of the surgical and nonsurgical cosmetic and therapeutic providers.

One problem with existing systems is the lack of anonymity. Buyers for medical services do not want to share their personal medical information with a large number of potential providers who will not end up performing the desired services. In order for buyers to have confidence in a software system, the system must be able to not share the buyers' private medical information until the provider has agreed to perform the desired service.

It is therefore an object of the present invention to provide an efficient software-based system to facilitate transactions between potential buyers and potential providers. While the present invention may have wide applicability, the present invention is specifically designed to facilitate transactions for surgical and nonsurgical cosmetic and therapeutic procedures. It is further an object of the present invention to provide a system that keeps the personal information of the potential buyer confidential until the provider has agreed to perform said transaction with the potential buyer. Moreover it is an object of the present invention to provide a system whereby the provider and the buyer are able to remain anonymous until a provider accepts an offer, at which point Still a further object of the present invention is to provide a system whereby the provider may select the time during which a procedure occurs, ensuring that the provider can perform the procedure at a time during which capacity would otherwise be underutilized.

### BRIEF DESCRIPTIONS OF THE DRAWINGS

FIG. 1 is a block diagram of the preferred embodiment of the present invention displaying the information exchange between the provider and the buyer as negotiated by the procedural brokering service.

FIG. 2 is a flow chart diagram of the preferred embodiment of the present invention displaying the process overview of the method of brokering purchases of procedural services.

FIG. 3 is a block diagram of the preferred embodiment of the present invention displaying the associated variables present in the Appointment opening submitted by the provider.

FIG. 4 is a flow chart diagram of the preferred embodiment of the present invention displaying the steps of receiving the appointment opening from the provider account.

FIG. 5 is a block diagram of the preferred embodiment of the present invention displaying the associated variables present in the appointment opening submitted by the buyer.

FIG. 6 is a flow chart diagram of the preferred embodiment of the present invention displaying the steps of receiving the appointment offer from the buyer account.

FIG. 7 is a flow chart diagram of the preferred embodiment of the present invention displaying the steps of receiving the transferable payment type from the buyer account.

FIG. 8 is a flow chart diagram of the preferred embodiment of the present invention displaying the steps of matching the appointment offer to the appointment opening.

FIG. 9 is a block diagram of the preferred embodiment of the present invention displaying the associated variables present in the anonymized appointment offer created by the system.

FIG. 10 is a flow chart diagram of the preferred embodiment of the present invention displaying the steps of creating the anonymized appointment offer.

FIG. 11 is a flow chart diagram of the preferred embodiment of the present invention displaying the steps of exporting the anonymized appointment offer to the provider account.

FIG. 12 is a flow chart diagram of the preferred embodiment of the present invention displaying the steps of receiving the offer acceptance from the provider account.

FIG. 13 is a flow chart diagram of the preferred embodiment of the present invention displaying the steps of exporting the transferable payment type and the buyer identifier to the provider account.

FIG. 14 is a flow chart diagram of the preferred embodiment of the present invention displaying the steps of exporting the provider identifier and the offer acceptance notification to the buyer account.

### DETAIL DESCRIPTIONS OF THE INVENTION

All illustrations of the drawings are for the purpose of describing selected versions of the present invention and are not intended to limit the scope of the present invention.

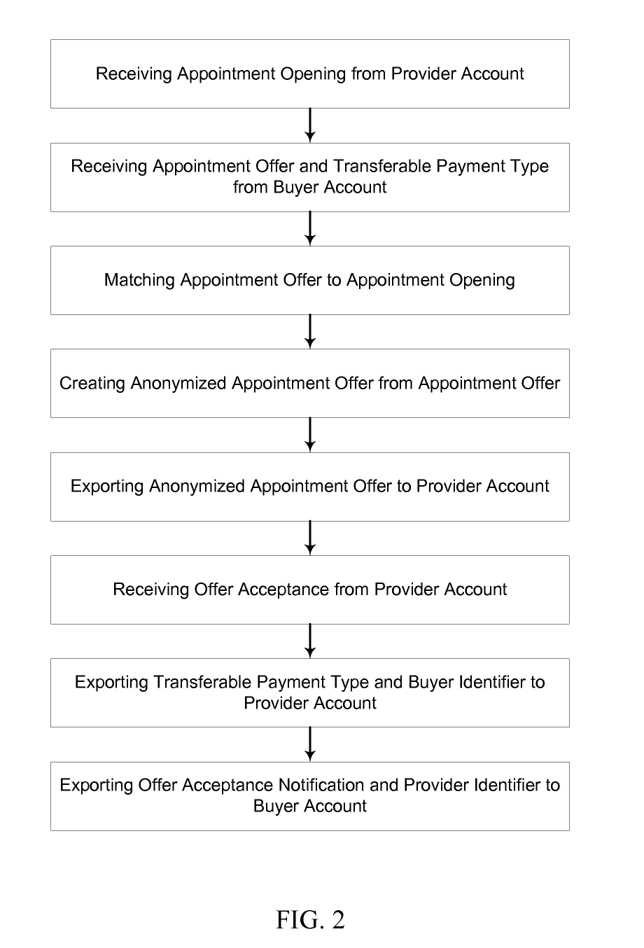

Referencing FIG. 2, the present invention is a method for brokering purchases of procedural services between a buyer and at least one professional service provider. The method provides professional service providers offering procedural services with access to potential clients to fill appointment availabilities by providing a networked system that receives, verifies, and negotiates appointment openings and appointment offers while providing privacy to both parties until a transaction is conducted. The method enables professional services providers to list the appointment availabilities to potential clients for a wide range of services. The method provides potential clients with the opportunity to submit offers for appointment availabilities by entering various parameters that include but are not limited to, the particular medical procedure, the radial distance from a selected location and the time range that the appointment is available. The method allows potential clients to make anonymous offers that are delivered to a professional service provider for review. The method negotiates and exchanges the personal information for both parties upon the acceptance of an offer. It should be noted that professional service providers are hereinafter referred to as provider unless otherwise specified. Furthermore it should be noted that potential clients are hereinafter referred to as buyers unless otherwise specified. Moreover, it should be noted that references to the construct in which the method is being operated is hereinafter referred to as the system, unless otherwise specified.

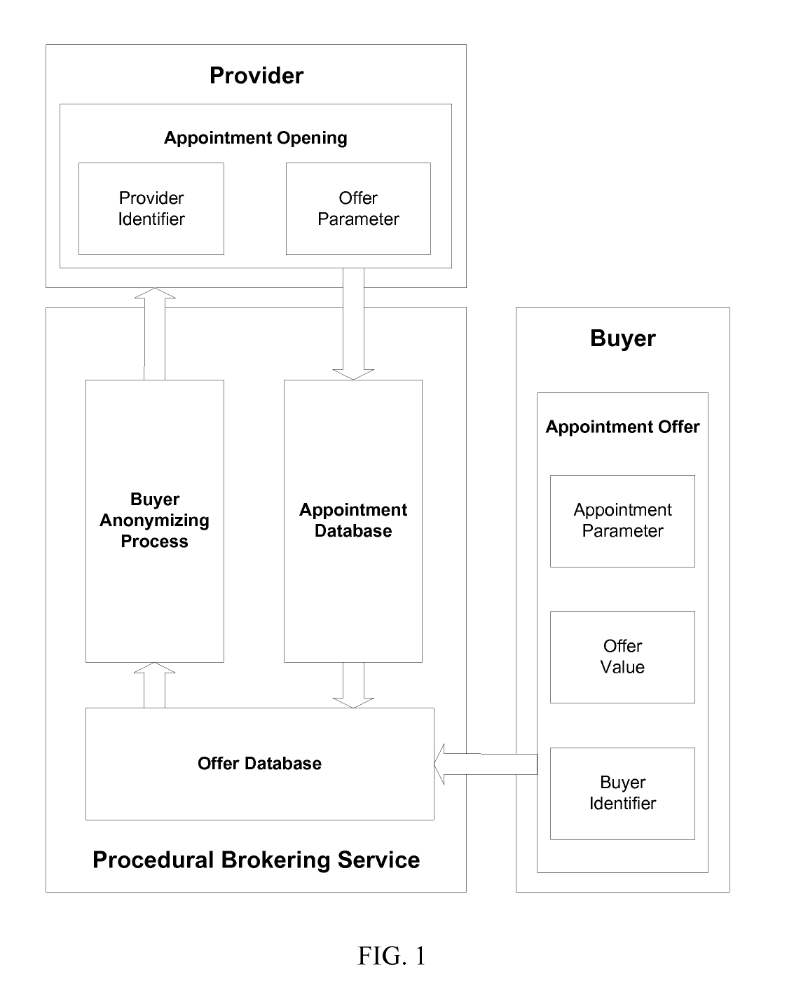

Referencing FIG. 1, the method for brokering purchases of procedural services is provided with a networked system that contains a provider account, a buyer account, an appointment database, and an offer database. The provider account serves as the source of provider submitted information, as well as the destination of system negotiated information sets. Similarly the buyer account serves as the source of buyer submitted information, as well as the destination of system negotiated information sets. The appointment database serves as a data construct that aggregates the appointment openings submitted by the providers through their provider accounts. The appointment database additionally serves to provide the facilitated sorting and retrieval of information stored within. Similarly, the offer database serves as the data construct that aggregates the appointment offers submitted by the buyers through their buyer account.

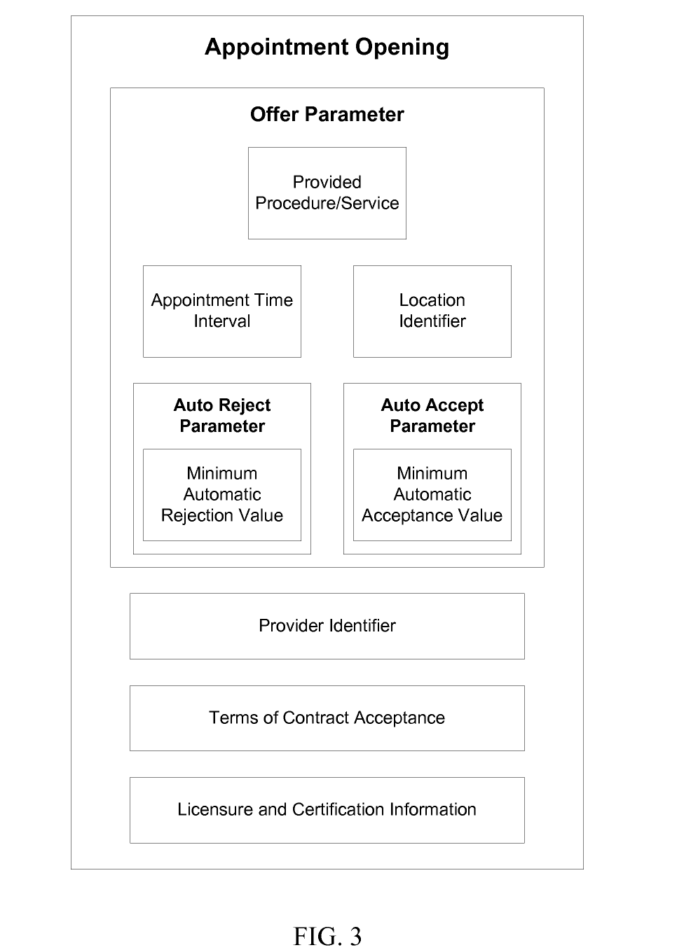

Referencing FIG. 3, the method for brokering purchases of procedural services receives appointment availabilities, hereinafter referred to as appointment openings unless otherwise specified, from the provider by way of the provider account. The appointment opening is an information set that serves two functions, it provides the system with details regarding the particulars of the appointment availability and specific information linking it to a particular provider account, as well as providing the system with determinants for initiating automatic responses to specific conditions. The process of receiving the appointment opening comprises the steps of receiving a provider identifier, an offer parameter, a terms of contract acceptance, and licensure and certification information. The provider identifier is an information set that is used to distinguish the appointment opening as being associated with the provider account. The terms of contract acceptance is an acknowledgement and acceptance of a legal agreement covering indemnity and liability, as well as conditional agreements associated with the submission of the appointment opening to the system. The offer parameter provides the system with the particulars of the appointment opening, as well as determinants that allow for automated actions for appointment offers. The offer parameter comprises a provided procedure/service, the appointment time interval, and a location identifier. The provided procedure/service is the particular procedure/service that is associated with the appointment opening, wherein the provided procedure/service may include but is not limited to surgical and non-surgical medical procedures, medical grade cosmetic procedures, dental services including cosmetic dentistry services, alternative medical/holistic medical services, medical counseling/psychiatric services, and chiropractic services. The appointment time interval is the particular time and date that the appointment opening is occurring. The location identifier is the location information where the appointment opening is occurring. The offer parameter further comprises an auto rejection parameter and an auto acceptance parameter. The auto rejection parameter comprises a minimum automatic rejection value, while the auto acceptance parameter comprises a minimum automatic acceptance value. The licensure and certification information is the documentation submitted from the provider account that asserts that the provided procedure/service offered in the appointment opening is to be conducted by a currently licensed and/or certified provider.

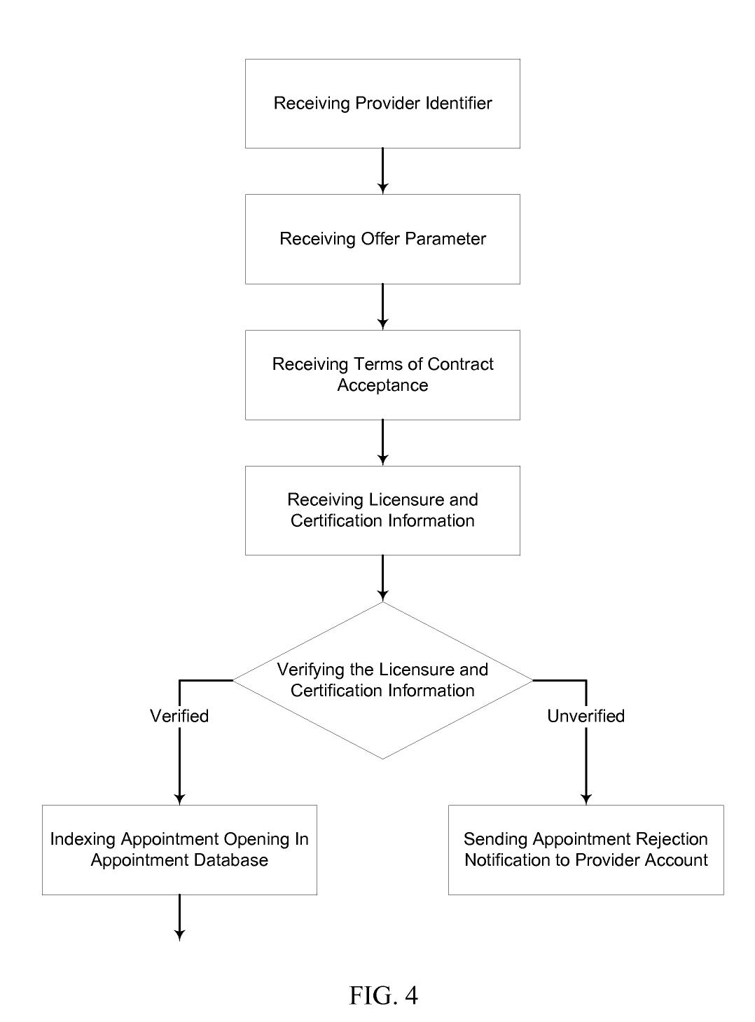

Referencing FIG. 4, upon submission of the appointment opening, the system initiates verification of the licensure and certification information by way of a licensure and certification process. The licensure and certification process verifies the licensure and certification information received by leveraging network accessible automated verification systems or through other existing verification methods, but provides the ability for the system to utilize developing and yet to be implemented verification methods. Dependent on the results of the licensure and certification process the system proceeds to either indexing the appointment opening in the appointment database or delivering an appointment rejection notification to the provider account. If the licensure and certification process is able to determine that the licensure and certification information is current and valid for the provider conducting the provided procedure/service, then the system indexes the received appointment opening in the appointment database. If the licensure and certification procession determines the licensure and certification information received is not current and/or valid for the provider conducting the provided procedure/service, then the system creates the appointment rejection notification, wherein the appointment rejection notification details that the appointment opening cannot be accepted due to the licensure and certification information not being current or valid. The system then delivers the appointment rejection notification to the provider account. Additionally, creation of the appointment rejection notification would prompt the system to denote the provider account as being ineligible resulting in the provider account not receiving any offers until the licensure and certification information are updated.

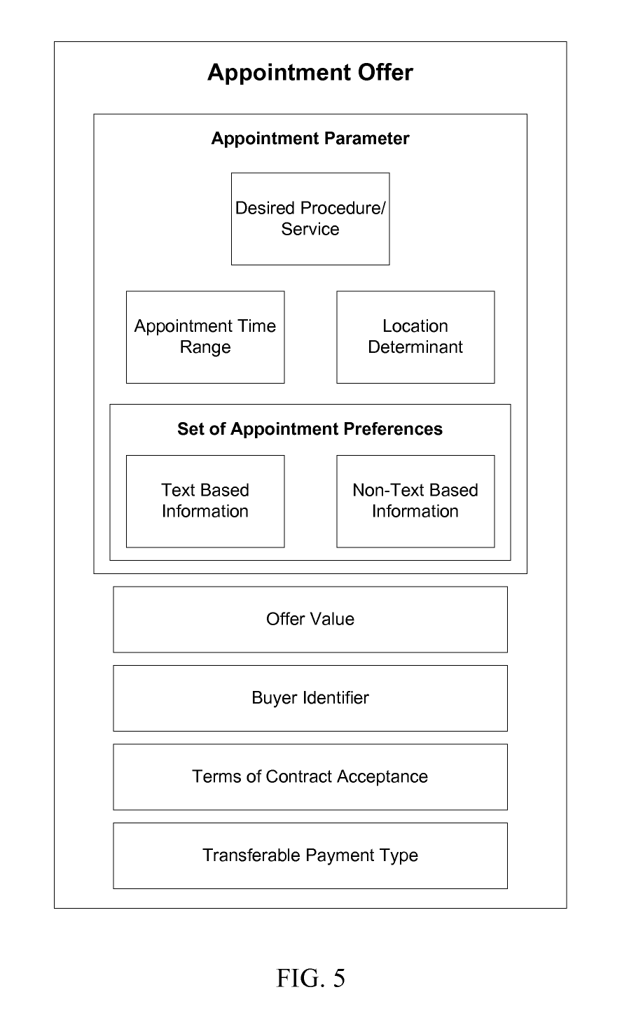

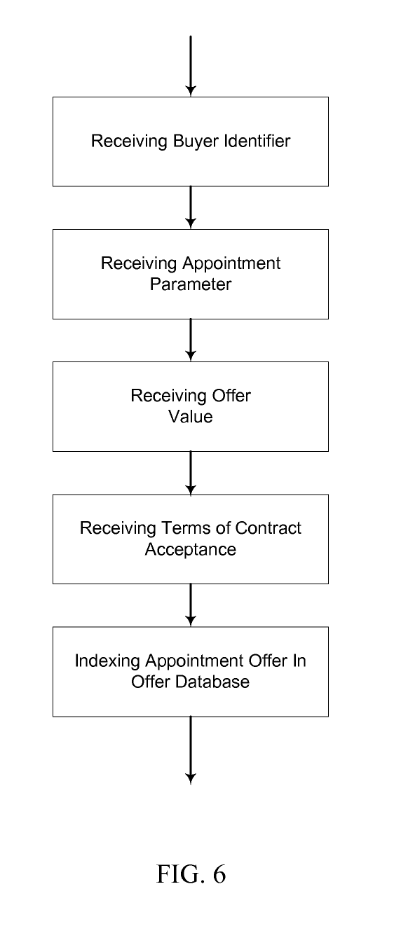

Referencing FIG. 5 and FIG. 6, the method of brokering purchases of procedural services receives an appointment offer. The appointment offer is an information set received from the buyer account for negotiating the approval of the appointment opening. The information set of the appointment offer comprises an appointment parameter, an offer value, a buyer identifier, and a terms of contract acceptance. The appointment parameter comprises a desired procedure/service, a location determinant, an appointment time range, and a set of appointment preferences. The desired procedure/service is a particular procedure/service sought by the buyer that is compared to the provided procedure/service of the appointment opening. The location determinant is utilized to select the appointment opening based on the location identifier, wherein the location determinant can function as a search radius origination from a point selected by the buyer or as a selected city, state, region, or geographic identifier. The appointment time range is utilized to select the appointment opening based on the appointment time interval. The appointment time range contains a first time instance and a second time instance wherein the appointment time interval must fall within the first time instance and the second time instance for the appointment opening to be selected. The set of appointment preferences contain personal information related to the buyer which are used by providers in determining the acceptance of a particular appointment offer. The set of appointment preferences comprises text based information and non-text based information. Text based information contains written descriptions of the buyers particular preferences for a particular procedure/service as well as pertinent information regarding the desired procedure or service which can include but is not limited to information regarding known allergies, past treatments, treatment preferences, and any medically relevant information. The non-text based information is any submitted information medium containing pertinent information regarding the desired produce/service, wherein information medium can include but is not limited to the photographic submission, video submission, and/or audio submissions as well as any combination thereof. The offer value is a set value that represents the amount the buyer wishes to pay for the appointment opening. The buyer identifier is an information set is that is used to distinguish the appointment offer as being associated with the buyer account. The terms of contract acceptance is an acknowledgement and acceptance of a legal agreement covering indemnity and liability, as well as conditional agreements associated with the submission of the appointment offer to the system. Upon receiving the submission of the appointment offer, the system indexes the appointment offer into the offer database.

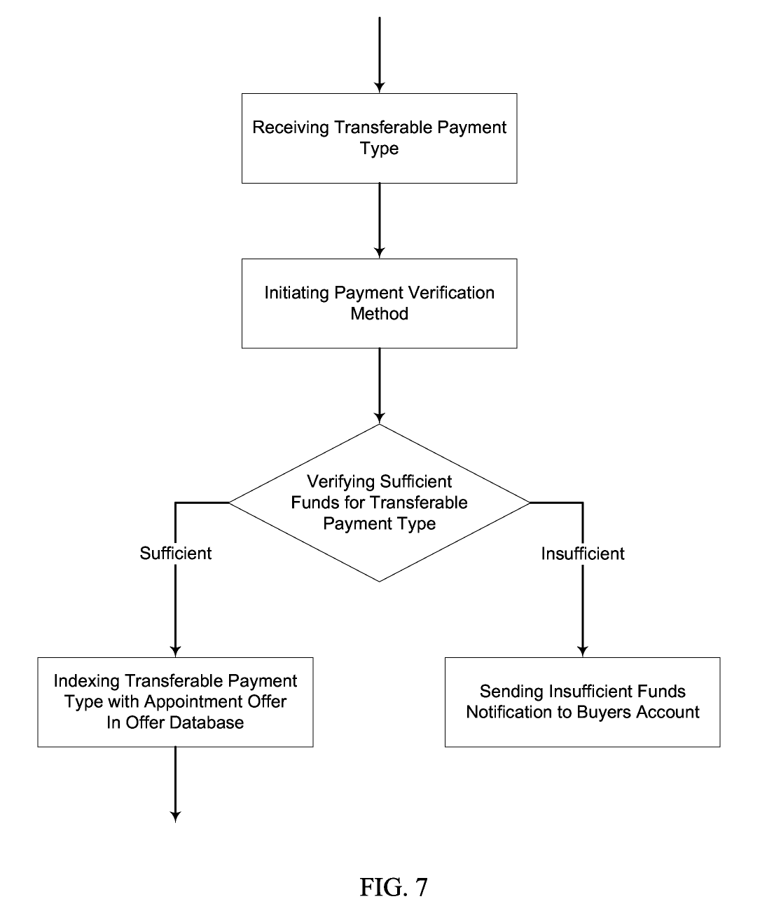

Referencing FIG. 7, the method of brokering the purchase of procedural services receives a transferable payment associated with the appointment offer. The transferrable payment type is a transaction vehicle that is used to pay for the provided procedure/service. The transferable payment type can be processed by the system by way of a merchant services program which exchanges funds between the provider and the buyer or the transferable payment type can be handed over directly to the provider's merchant services program. The process of receiving the transferable payment type comprises the steps of receiving the transferable payment type, followed by verifying sufficient funds for the transferable payment type associated with the appointment offer, which depending on the outcome results in the system indexing the transferable payment type with the appointment offer in the offer database or creating and delivering an insufficient funds notification to the buyer account. Verification of the transferable payment type is accomplished through the use of a payment verification method wherein the payment verification method compares the offer value to funds available to the transferable payment type. The payment verification method determines the sufficient funds associated with the transferable payment type by leveraging network accessible automated verification systems or through other existing verification methods, but provides the ability for the system to utilize developing and yet to be implemented verification methods. Through the implementation of the payment verification method the system is able to determine the preceding step. If the payment verification method determines that the transferable payment type contains the sufficient funds, then the system indexes the transferable payment type associated with the appointment offer in the offer database. If the payment verification method determines that the transferable payment type does not contain sufficient funds, then the system creates and delivers the insufficient funds notification to the buyers account.

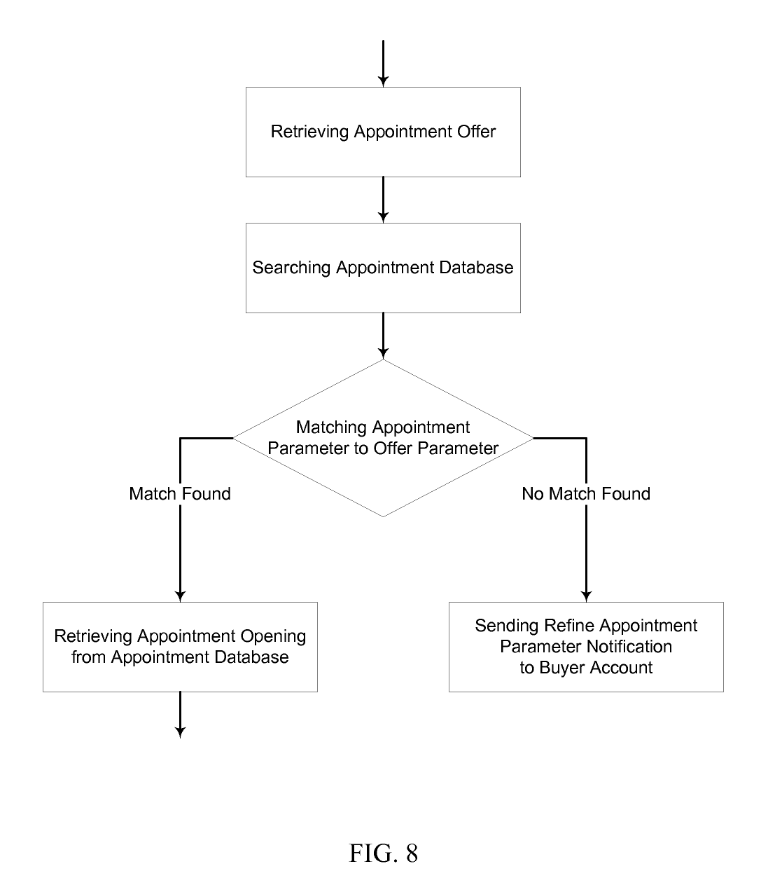

Referencing FIG. 8, the method of brokering purchases of procedural services matches the appointment offer to the appointment opening in the appointment database. The matching of the appointment offer comprises the steps of retrieving the appointment offer, searching the appointment database for an appointment opening and retrieving the appointment opening or the delivering a refine appointment parameter notification to the buyer account, depending on the results of the database search. The system initiates the matching processes upon submission and indexing of the transferable payment type in the offer database. The system retrieves the appointment offer and utilizes the appointment parameters as the search determinants for identifying a matching appointment opening. The search values are weighted equally, wherein matches between the provided procedure/service, the location identifier, and the appointment time interval to the desired procedure/service, the location determinant, and the appointment time range, respectively, take no priority over one another due to the matching of the appointment search request and the appointment opening being driven by a complete match and not a partial match. If the appointment database search determines that the appointment opening contains the offer parameter matching the appointment parameter, the system proceeds to retrieving the appointment opening. If the system determines that the appointment opening does not contain the offer parameter matching the appointment parameter, the system creates the refine appointment parameter notification, wherein the refine appointment parameter notification details the appointment parameters could not be matched with the offer parameter in the appointment database. After creation the system initiates delivery of the refine appointment parameter notification to the buyer account.

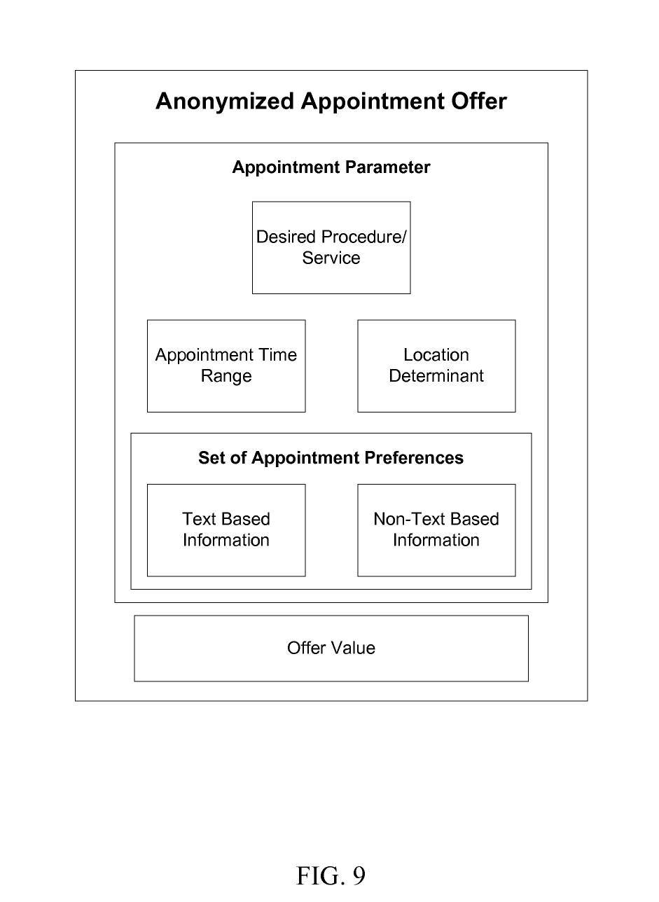

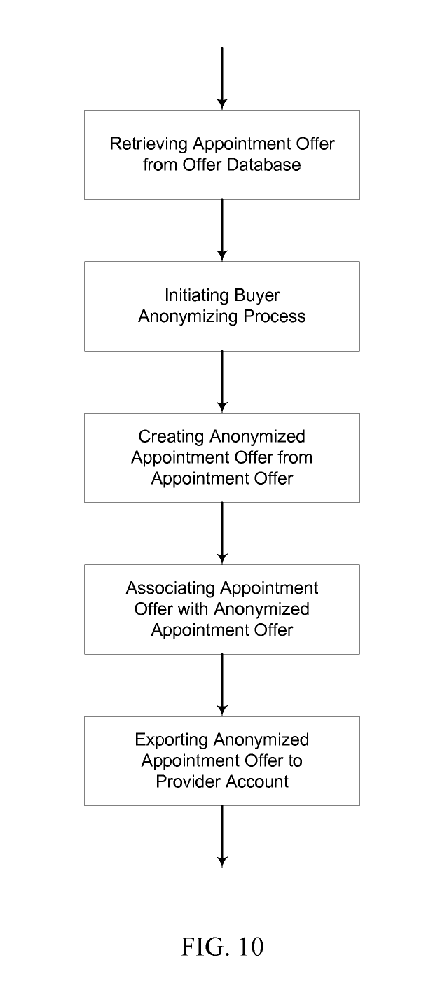

Referencing FIG. 9 and FIG. 10, the method of brokering purchases of procedural services creates the anonymized appointment offer associated with the appointment offer. The process of creating the anonymized appointment offer comprises the steps of retrieving the appointment offer from the offer database and creating the anonymized appointment offer by way of a buyer anonymizing process. The process is initiated upon the successful completion of the matching process. The system retrieves the appointment offer from the offer database. After which the system initiates the buyer anonymizing process. The buyer anonymizing process creates an anonymized appointment offer from the retrieved appointment offer by extracting the offer value and the brief patient history. The buyer anonymizing process then combines the two information sets under the anonymized appointment offer. Additionally the buyer anonymizing process includes an identifier with the anonymous appointment offer that establishes an association with the appointment offer. This identifier enables retrieval of the appointment offer from the anonymized appointment offer upon offer acceptance by a provider. After creating the anonymized appointment offer, the system exports the offer to the provider account for review.

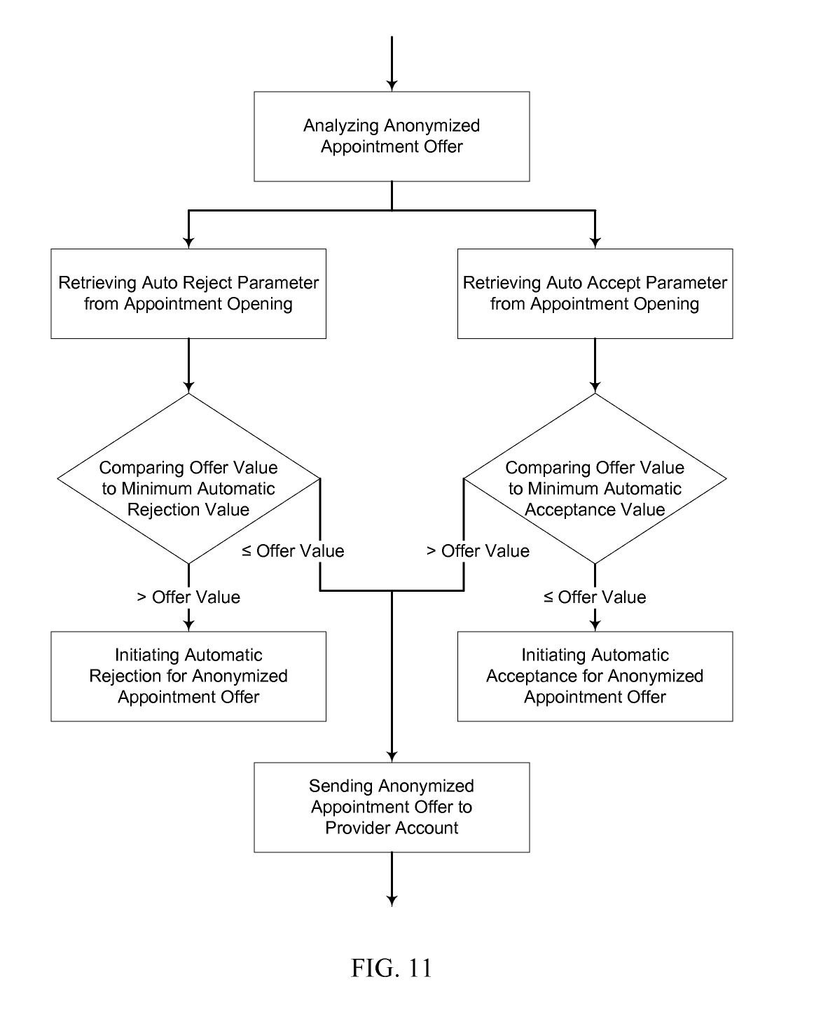

Referencing FIG. 11, the method of brokering the purchase of procedural services exports the anonymized appointment offer to the provider account, the process of exporting the anonymized appointment offer comprises the steps of retrieving the appointment opening from the appointment database, analyzing the offer value with an auto reject parameter of the offer parameter, and analyzing the offer value with an auto accept parameter of the offer parameter. Prior to delivering the anonymized appointment offer to the provider account, the system retrieves the appointment opening from the appointment database. After retrieving the appointment opening the system initiates an analysis between the offer value against the auto reject parameter and the auto accept parameter of the offer parameter. The driving values associated with the auto reject parameter and the auto accept parameters are the minimum automatic rejection value and the minimum automatic acceptance value, respectively. It should be noted that the auto reject parameter and the auto accept parameter are present but do not have to have a minimum automatic rejection value and the minimum automatic acceptance value set, which can be understood as having the ability to selectively incorporate the functionality of automated acceptance or rejection.

The minimum automatic rejection value can be either a global value or a service provider specific value input. The global value is value set by the system for a particular procedural service, which can be either a market stabilizing value selected by users of the system or a system calculated value created from data analysis. The provider specific value is a value selected by the provider for the appointment opening. The system determines if the anonymized appointment offer is automatically rejected by comparing the minimum automatic rejection value against the offer value. If the minimum automatic rejection value is determined to be less than or equal to the offer value, then the system does not initiate and automatic rejection for the anonymized appointment offer and sends the anonymized appointment offer to the provider account for review. If the minimum automatic rejection value is determined to be greater than the offer value, then the system initiates an automatic rejection for the anonymized appointment offer which creates and automatic appointment rejection notification that is exported to the buyer account.

The minimum automatic acceptance value is a calculated value wherein the minimum automatic acceptance value is obtained by multiplying a weighted time and date dependent percentage value by a retail value associated with a procedure/service provided. Calculation of the minimum automatic acceptance value is represented by the following equation:

MAAV_{P}=RpₒDₙTₙ

MAAVₚ is the minimum automatic acceptance value for a particular procedure/service, Rpₒ is the retail price for the particular procedure/service; Dₙ is the weighted value for a given day, wherein Dₙ is a value weighted greater than or equal to zero and a value less than or equal to 1; Tₙ is the weighted value for a given time, wherein Tₙ is a value weighted greater than or equal to zero and a value less than or equal to 1. The minimum automatic acceptance value can use global values, provider specific values, or provider submitted values. The global values use data analysis to determine the optimal Dₙ and Tₙ values for the particular time interval of the appointment opening using information gathered from all interaction with the system. The provider specific values use data analysis to determine the optimal Dₙ and Tₙ values for the particular time interval of the appointment opening using information gathered from interactions between the system and the provider. The provider submitted values are values that are determined by the provider as being optimal for the particular time interval of the appointment opening. The system determines if the anonymized appointment offer is automatically accepted by comparing the minimum automatic acceptance value against the offer value. If the minimum automatic acceptance value is determined to be greater than the offer value, then the system does not initiate an automatic acceptance for the anonymized appointment offer and send the anonymized appointment offer to the provider account for review. If the minimum automatic acceptance value is determined to be less than or equal to the offer value, then the system initiates an automatic acceptance for the anonymized appointment offer which creates an automatic appointment acceptance notification that is exported to the buyer account.

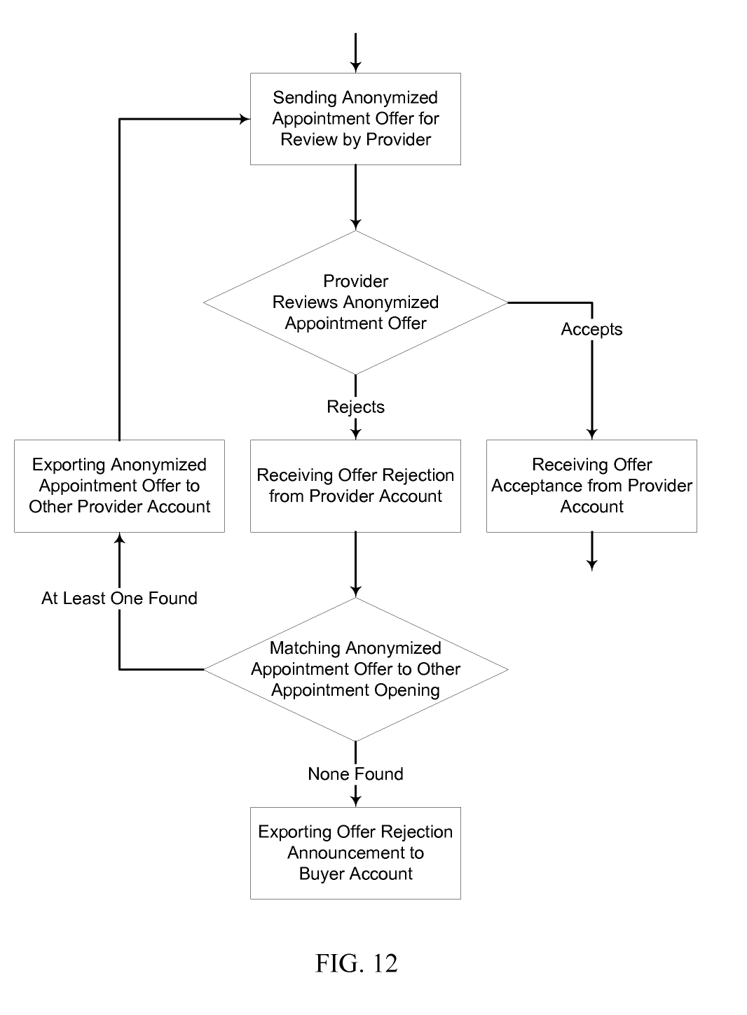

Referencing FIG. 12, upon receiving the anonymized appointment offer, the provider has a limited amount of time to accept or reject the anonymized appointment offer. The provider is able to determine if they would like to accept the new patient or reject them based on the information received. The provider is able to view the appointment preferences and the offer value to better help decide on the best course of action. If the provider decides to the reject the anonymized offer the system identifies another appointment opening containing matching offer parameters, then exports the anonymized appointment opening to the provider account of the other appointment opening. If the system is unable to match the anonymized appointment offer with other appointment openings in the appointment database, then the system creates an offer rejection announcement detailing that the buyers offer was unable to be matched. The system then exports the offer rejection announcement to the buyer account.

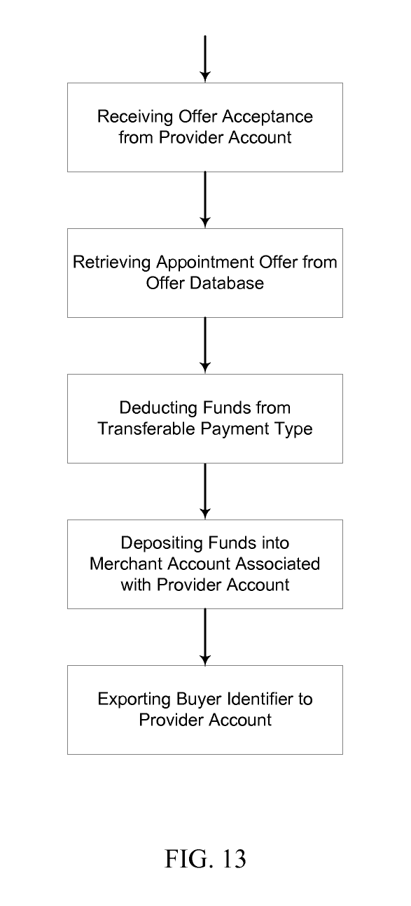

Referencing FIG. 13, the method of brokering the purchases of procedural services exports the transferable payment type and the buyer identifier, associated with the appointment offer, to the provider account. The process of exporting the transferable payment type and the buyer identifier to the provider account comprises the steps of receiving an offer acceptance from the provider account, retrieving the transferable payment type and the buyer identifier associated with the appointment offer from the offer database, deducting funds from the transferable payment type, and depositing the funds to a merchant account associated with the provider account. The offer acceptance is an acknowledgement and acceptance of the anonymized offer that was reviewed by the provider. Upon receiving the offer acceptance the system denotes the appointment offer as being matched to an appointment opening initiating a process to transfer funds from the transferable payment type to the merchant account of the provider account. The system then retrieves the buyer identifier and the transferable payment type associated with the appointment offer from the offer database. The system then deducts funds from the transferable payment type. The funds that the system deducts from the transferable payment type are equivalent to the quantity of the offer value. The system then deposits the funds to the merchant account associated with the provider account. During the process of transferring the funds the system exports the buyer identifier to the provider account. It should be clarified that the merchant account as described above could be provided as an integrated account or as an associated third party financial account. While the distinction between an integrated merchant account and a third party financial account could potentially require a variation of the process as described above, it should be considered an obvious difference since both account types are provided to receive funds deducted from the transferable payment type without detailing the length of time for a transfer nor the conditions associated with withdrawing funds.

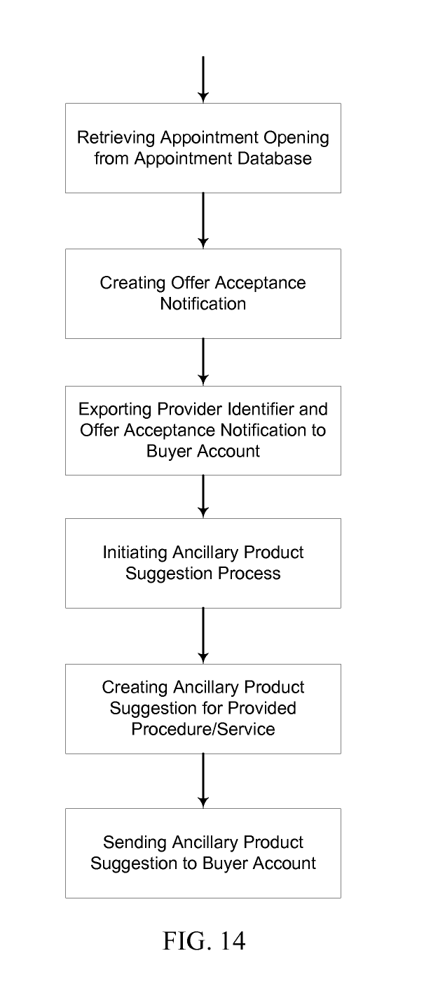

Referencing FIG. 14, the method of brokering the purchase of procedural services exports an offer acceptance notification and the provider identifier to the buyer account. The process of exporting the offer acceptance notification and the provider identifier to the buyer account further comprises the steps of retrieving the offer parameter and the provider identifier from the appointment database, initiating an ancillary product suggestion process, creating an ancillary product suggestion, creating the offer acceptance notification, exporting the offer acceptance notification, and sending the ancillary product suggestion The system initiates the retrieval of the offer parameter and the provider identifier from the appointment database upon exportation of the transferable payment type and the buyer identifier associated with the appointment offer to the provider account. After retrieval of the offer parameter and the provider identifier the system initiates the ancillary product suggestion process. The ancillary product suggestion process creates an ancillary product suggestion for the provided procedure/service, wherein the system contains information regarding products generally associated with a particular provided procedure/service and matches the products. After creation of the ancillary product suggestion the system creates the offer acceptance notification. The offer acceptance notification details the information about the particular appointment opening. Upon creation the system exports the offer acceptance notification and the provider identifier to the buyer account. Additionally the system sends the ancillary product suggestion to the buyer account. Furthermore, while creation and delivery of the ancillary product suggestion is described as occurring after an appointment offer is matched to an appointment opening, it should be clarified that the delivery of the ancillary product suggestion can occur prior to the date of the appointment opening, as well as following the appointment date.

In the preferred embodiment of the present invention the method utilizes accounts for both the buyer and the providers. While the creation of an account or profile are not described in detail, it should be understood that the process of creating an account or profile for either provider or buyers would carry the same requirements as any existing service which utilizes the profiles or accounts. Furthermore, it should be understood that the profiles and accounts utilizes by the system can be utilized to provide the same benefits currently associated current profiles and accounts. These benefits include but are not limited to keeping a transaction history and saving account preferences.

In the preferred embodiment of the present invention the appointment opening s containing automated acceptance and rejection parameters are not given preference over appointment opening that do not have the parameters initiated. They system accomplishes this by including a randomization algorithm that selects providers solely on eligibility regardless of having active automated parameters or deactivated parameters. This functionality allows providers to have an equal opportunity to receive potential clients for their appointment openings and this methodology does not allow the system to favor any provider over another provider.

In the preferred embodiment of the present invention the account system for providers and buyers can circumvent the requirement to enter the licensure and certification information or the transferable payment type, for each instance an appointment opening or appointment offer is created. The account system can be set up in a manner that would allow providers to enter their certification for a particular provided procedure/service once for each particular procedure/service and merely select from a list of already submitted licenses and certificates associated with their account. The system would verify the licensure and certification information at the creation of a new appointment opening to ensure that it is valid and current.

In the preferred embodiment of the present invention the method provides a system that is integrated with a provider's facility management software. The system has access to the provider's digital appointment book allowing the system to detect appointment availabilities in the digital appointment book and automatically create an appointment opening for the provider. The system is also able to automatically book and update an appointment opening upon fulfillment of a particular set of predefined requirements created by the provider or the provider's facility management staff. These features are greatly enhanced by the fact that all interactions are exported or received from the provider account which can utilizes past interactions to create predictions that would improve the efficiency of a provider's facility. Additionally, it should also be considered an obvious difference to describe the features of the integrated system as function that can be made available individually or in combination with each other. Furthermore, it should be understood that the current embodiment of the facility management software could be utilized with third party software appointment ledger software as well as a system provided appointment ledger software. While the provided software and the third party software would contain variations, it should be understood that the process of automatically updating appointment openings would remain the same. Moreover, it should be understood that integration with appointment ledger software is provided but can be opted out for use by providers who wish to use the traditional pen and paper appointment ledger systems.

In the preferred embodiment of the present invention the licensure and certification process is utilized to determine that the licensure and certification information submitted is current and valid for the provider. While the verification process mainly focuses on license and certification verification it should be noted that the system can incorporate social network reviews and other performance grading databases in addition to the licensure and certification information. The system can include the percentage reviews with the anonymized appointment opening or use the review system as a determinant for the accepting the appointment opening.

In the preferred embodiment of the present invention the system allows buyers to self-cancel a matched appointment offer within 24 hours of matching with an appointment opening. By allowing buyers to cancel the appointment opening within 24 hours of a match, the present invention can ensure submitted offers are not mistaken as bids nor have the system mistaken as an auction type system.

In the preferred embodiment of the present invention the system collects data from each interaction between providers and buyers. The collection of these interactions allows the system to conduct information analysis on the transaction data, patient data, and provider data, in order to improve system interaction as well as improve industry forecasting, geo-specific growth trends, and a plurality of additional consumer interaction analysis. Furthermore it should be noted that the system allows for historical retention of both the patient and providers that have interacted in order to be used to make better offer matches as information it populated in the system.

In the preferred embodiment of the present inviting the system provides anonymity to both participating user groups by including anonymization features and by withholding the identifying information of the particular group. It should be noted that while the buyer utilizes an anonymizing process to submit an offer to a provider, the nature of the interaction with the provider allows them to maintain anonymity until an offer is accepted.

Although the invention has been explained in relation to its preferred embodiment, it is to be understood that many other possible modifications and variations can be made without departing from the spirit and scope of the invention as hereinafter claimed.

What is claimed is:

1. A method for brokering purchases of procedural services between a buyer and at least one professional service provider by executing computer executable instructions stored on a non-transitory computer readable medium comprises:
providing a buyer account, a provider account, an appointment database, and an offer database;
receiving an appointment opening from the provider account, wherein the appointment opening contains an offer parameter and a provider identifier;
receiving an appointment offer from the buyer account, wherein the appointment offer contains an appointment parameter, an offer value, and a buyer identifier;
receiving a transferable payment type from the buyer account, wherein the transferable payment type is associated with the appointment offer;
matching the appointment offer to the appointment opening of the appointment database, wherein the appointment offer and the appointment opening are matched by the appointment parameter and the offer parameter, respectively;
creating an anonymized appointment offer, wherein the anonymized appointment offer is associated with the appointment offer;
exporting the anonymized appointment offer to the provider account;
receiving an offer acceptance from the provider account, wherein the offer acceptance is for the anonymized appointment offer;
exporting the buyer identifier to the provider account, wherein the buyer identifier is associated with the appointment offer; and
exporting an offer acceptance notification and the provider identifier to the buyer account.

2. The method of receiving the appointment opening from the provider account as claimed in claim 1 further comprises the steps of:
receiving a provided procedure/service, a location identifier, an appointment time interval, an auto reject parameter, and an auto accept parameter for the offer parameter;
receiving licensure and certification information for the appointment opening;
verifying the licensure and certification information by a licensure and certification process, wherein the licensure and certification process utilizes available systems and methods to determine the validity of the certification and licensure information received to ensure the appointment opening is being offered by a currently licensed and/or certified procedural service provider;
receiving a terms of contract acceptance, wherein the terms of contract acceptance is a legal agreement covering indemnity and liability, as well as conditional agreements associated with submission of the appointment opening;
indexing the appointment opening in the appointment database,
if the licensure and certification process determines the licensure and certification information is valid for the appointment opening; and
sending an appointment rejection notification to the provider account, wherein the appointment rejection notification details the appointment opening cannot be accepted,
if the licensure and certification process determines the licensure and certification information is not valid for the appointment opening.

3. The method of receiving the appointment offer from the buyer account as claimed in claim 1 further comprises the steps of:
receiving a desired procedure/service, a location determinant, an appointment time range, and a set of appointment preferences for the appointment parameter, wherein the set of appointment preferences comprises text based information and non-text based information.
receiving a terms of contract acceptance, wherein the terms of contract acceptance is a legal agreement covering indemnity and liability as well as conditional agreements associated with submission of the appointment offer; and
indexing the appointment offer in the offer database.

4. The method of receiving the transferable payment type from the buyer account as claimed in claim 1 further comprises the steps of:
verifying sufficient funds for the transferable payment type associated with the appointment offer by way of a payment verification method, wherein the payment verification method compares the offer value to funds present contained in the transferable payment type;
indexing the transferable payment type associated with the appointment offer in the offer database,
if the payment verification method determines the transferable payment type contains the sufficient funds; and
sending an insufficient funds notification to the buyers account, wherein the insufficient funds notification details the transferable payment type cannot be accepted,
if the payment verification method determines the transferable payment type does not contain the sufficient funds.

5. The method of matching the appointment offer to the appointment opening as claimed in claim 1 further comprises the steps of:
providing a provided procedure/service, a location identifier, and an appointment time interval for the offer parameter;
providing a desired procedure/service, a location determinant, and an appointment time range for the appointment parameter;
retrieving the appointment offer from the offer database;
searching the appointment database for the offer parameter matching the appointment parameter;
retrieving the appointment opening from the appointment database,
if the offer parameter contains the provided procedure/service, the location identifier, and the appointment time interval matching the desired procedure/service, the location determinant, and the appointment time range for the appointment parameter; and
sending a refine appointment parameter notification to the buyer account, wherein the refine appointment parameter notification details the appointment parameters could not be matched with the offer parameter in the appointment database,
if the offer parameter does not contain the provided procedure/service, the location identifier, and the appointment time interval matching the desired procedure/service, the location determinant, and the appointment time range for the appointment parameter.

6. The method of creating an anonymized appointment offer as claimed in claim 1 further comprises the steps of:
retrieving the appointment offer from the offer database;
initiating a buyer anonymizing process for the appointment offer;
creating the anonymized appointment offer containing the appointment parameter and the offer value associated with the appointment offer, wherein the buyer anonymizing process provides an association between the anonymized appointment offer and the appointment offer allowing for facilitated retrieval of information upon an offer acceptance.

7. The method of exporting the anonymized appointment offer as claimed in claim 1 further comprises the steps of:
analyzing the offer value with an auto reject parameter of the offer parameter;
analyzing the offer value with an auto accept parameter of the offer parameter; and
sending the anonymized appointment offer to the provider account,
if analysis of the offer value with the auto reject parameter and the auto accept parameter does not initiate an automatic rejection or an automatic acceptance of the appointment offer.

8. The method of analyzing the offer value with the auto reject parameter as claimed in claim 7 further comprises the steps of:
initiating the automatic rejection for the anonymized appointment offer,
if the auto reject parameter contains a minimum automatic rejection value greater than the offer value;
exporting an automatic appointment rejection notification for the anonymized appointment offer;

9. The method of analyzing the offer value with the auto accept method as claimed in claim 7 further comprises the steps of;
initiating the automatic acceptance for the anonymized appointment offer;
if the auto accept parameter contains a minimum automatic acceptance value less than or equal to the offer value, wherein the minimum auto acceptance value is calculated by multiplying a weighted time and date dependent percentage value by a retail value associated with a procedure/service provided; and
exporting an automatic offer acceptance notification for the anonymized appointment offer.

10. The method of receiving an offer acceptance as claimed in claim 1 further comprises the steps of:
matching the anonymized appointment offer to another appointment opening in the appointment database, wherein the other appointment opening contains an offer parameter matching the appointment parameter of the anonymized appointment offer,
if provider account exports an offer rejection for the anonymized appointment offer;
exporting an offer rejection announcement to the buyer account, wherein the offer rejection announcement details the rejection of the anonymized appointment offer,
if the system is unable to match the anonymized appointment offer with other appointment openings.

11. The method of exporting the buyer identifier associated with the appointment offer to the provider account as claimed in claim 1 further comprises the steps of:
retrieving the transferable payment type and the buyer identifier associated with the appointment offer from the offer database;
deducting funds from the transferable payment type, wherein the funds deducted from the transferable payment type are equivalent to the offer value; and
depositing the funds to a merchant account associated with the provider account.

12. The method of exporting the offer acceptance notification and the provider identifier to the buyer account as claimed in claim 1 further comprises the steps of:
retrieving the offer parameter and the provider identifier from the appointment database;
initiating an ancillary product suggestion process for the appointment opening matching the appointment offer;
creating an ancillary product suggestion for a provided procedure/service; and
sending the ancillary product suggestion to the buyer account.

13. The method for brokering purchases of procedural services between a buyer and at least one professional service provider as claimed in claim 1 further comprises the steps of:
collecting a service fee from the provider account on an aggregate basis, wherein service fees are collected on scheduled intervals or upon fulfillment of conditional requirements predefined by the system;

14. The method for brokering purchases of procedural services between a buyer and at least one professional service provider as claimed in claim 1 further comprises the steps of:
providing a communicably coupled facility management software, wherein the communicably coupled facility management software is a software based appointment ledger program which creates and updates appointment openings based on appointment availabilities logged into the appointment ledger program and the interactions between the provider account with appointment offers, respectively.
